(19) United States
(12) Patent Application Publication
(10) Pub. No.: US 2015/0044403 A1
(43) Pub. Date: Feb. 12, 2015

(54) HEAT SEALABLE NYLON FILM AND METHOD OF MAKING IT

(71) Applicant: DuPont Teijin Films U.S. Limited Partnership, Chester, VA (US)

(72) Inventors: Fenghua Deng, Richmond, VA (US); Moira Tayler, Cleveland (GB); Julian Neal Robinson, Easly (GB)

(21) Appl. No.: 14/383,287

(22) PCT Filed: Mar. 6, 2013
(86) PCT No.: PCT/US2013/029254

§ 371 Date: Sep. 5, 2014

Related U.S. Application Data
(60) Provisional application No. 61/607,212, filed on Mar. 6, 2012.

(51) Int. Cl. B65D 77/20; C09J 7/02; B65D 81/34; B65B 51/10; B65D 30/00; B65D 85/72

(52) U.S. Cl. CPC B65D 77/2024; B65D 31/005; B65D 85/72; B65D 81/34; B65B 51/10; C09J 7/0282; C09J 2477/006; C09J 2431/00; C09J 2423/00; C09J 2433/00; C09J 131/04
USPC 428/34.8; 428/355 AC; 428/355 EN; 428/35.7; 53/478; 53/477

(57) ABSTRACT

A composite film includes a nylon base film and a coextensive layer of adhesive composition that includes one or more polymers, wherein the one or more polymers taken together include in polymerized form: a) ethylene; b) one or more ester-containing monomers, constituting in a range from 5 to 50 wt % of the one or more polymers; and c) one or more carboxylic acid-containing monomers and optionally salt(s) thereof, constituting in a range from 0.5 to 20 wt % of the one or more polymers. A package may be prepared, including a lid made from the composite film heat sealed to a tray. A bag for packaging raw or processed meat may be made from the composite film. A food item may be contained in the package or bag.

### BACKGROUND OF THE INVENTION

Nylon (polyamide) films are widely used in packaging applications, due to their superior puncture resistance. They may for example be used to make puncture-resistant bags for meat and other food types, but the processes for making the bags typically involve high temperatures by which the nylon film surfaces are welded together to seal the bag. Thus, nylon films are not readily heat sealable, especially not heat sealable to other substrates.

Due to this lack of heat sealability, nylon films for packaging applications are commonly incorporated into multilayer structures. Often, these structures employ ethylene (co)polymer layers prepared by blown film or extrusion coating processes. Unfortunately, these processes tend to form relatively thick ethylene (co)polymer layers, and this can potentially destroy the dual ovenability of the composite film because ethylene copolymers often do not have good thermal stability and may also not be able to satisfy the extraction requirement for material used in dual ovenable cooking applications.

Nylon films have been used to make bags for storing and cooking food products, especially meat products. Due to the lack of good sealability, the bag is typically made by welding the Nylon surface together at high temperature. This high temperature welding typically results in leaks and pinholes in the bag. Due to the poor sealing characteristics, it is common to use bags that are sealed on three sides and to close them, after filling with food, by using metal clips. Food processers then can not use X-rays or other metal detection systems to detect foreign objects in the food. Nylon bags made by welding and using metal clips also typically will not self vent during the cooking cycle, due to the high strength of the nylon-nylon weld.

One potential way of addressing some of these problems would be to provide heat seal layers on nylon via solution coating rather than blown film or extrusion processes. Solution coating also offers the ability of achieving a broad range of coating thickness, which can aid in tailoring the seal performance. Solution coating has, however, been difficult to implement on nylon substrates because it has proven hard to identify compositions capable of forming a good coating on nylon while still providing the adhesive and cohesive strength required to provide good heat seal properties. Thus, compositions capable of providing these properties would be of commercial value.

### SUMMARY OF THE INVENTION

In one aspect, the invention provides a composite film including a nylon base film and a coextensive layer of adhesive composition including one or more polymers, wherein the one or more polymers taken together include in polymerized form:

a) ethylene;

b) one or more ester-containing monomers, constituting in a range from 5 to 50 wt % of the one or more polymers; and

c) one or more carboxylic acid-containing monomers and optionally salt(s) thereof, constituting in a range from 0.5 to 20 wt % of the one or more polymers.

In another aspect, the invention provides a package including a lid made from the composite film, wherein the lid is heat sealed to a tray.

In still another aspect, the invention provides a bag made from the composite film, suitable for packaging raw or processed meat.

In yet another aspect, the invention provides a method of packaging food that includes heat sealing the composite film of the invention to a tray containing a food item.

In a still further aspect, the invention provides a method of packaging food that includes closing a bag made from the composite film of the invention, wherein the bag contains a food item.

### DETAILED DESCRIPTION OF THE INVENTION

The invention provides methods and compositions for producing a heat seal layer on nylon films (including thermoformable nylon films) by solution coating. The resulting composite films can for example be used to make bags, or lids for tray containers. In particular, they may be used to prepare packages suitable for high temperature cooking and reheating of a food, such as for cook-in meat applications.

Using the solution-coating methods of this invention, thin heat seal coatings can be achieved and the seal strength can be easily tailored as needed for a given end-use requirement, for example when it is desired to provide a defined level of peelability. Coatings having a thickness of at most 15 μm, or at most 10 μm, or at most 5 μm can be obtained. Such thicknesses are difficult or impossible to obtain by conventional methods such as lamination, extrusion coating or coextrusion. The inventors have found that packages having lids made from the composite films of the invention, and bags made from the composite films, may be provided with the ability to self-vent during a cooking cycle in an oven. This can be achieved by simply using a sufficiently low coating thickness, the exact value of which depends upon a number of factors including the specific coating composition and the specific composition of the surface to which the composite film is heat sealed. The resulting packages or bag vents upon reaching a sufficiently high temperature, typically in a range from 300° F. (177° C.) to 450° F. (204° C.).

### Adhesive Compositions

Adhesive compositions according to the invention include one or more polymers, wherein the one or more polymers taken together comprise in polymerized form:

a) ethylene;

b) one or more ester-containing monomers; and

c) one or more carboxylic acid-containing monomers and optionally salt(s) thereof.

Exemplary carboxylic acid-containing monomers include acrylic acid, methacrylic acid, maleic acid and itaconic acid.

Exemplary ester-containing monomers include vinyl acetate, methyl (methyl)acrylate, ethyl (methyl)acrylate, propyl (methyl)acrylate, butyl (methyl)acrylate and/or other alkyl (methyl)acrylates. In some embodiments, at least a portion of the ester-containing monomer component is contributed by polybutanediol esters, for example polybutanediol (meth)acrylate.

It has now been found that in order for the adhesive to have both sufficient adhesive strength and sufficient cohesive strength for effective bonding to the nylon film, while still being able to create an effective heat seal under typical use conditions, proper selection of the amounts of carboxylic acid-containing monomer and ester-containing monomer is important. If the amount of carboxylic acid-containing monomer is too low, adhesion to the nylon is poor. However, too much carboxylic acid content may result in a melt onset temperature too high for proper heat seal formation, causing deformation of the nylon base layer during heat sealing or deformation of the substrate. Typically, the melt onset temperature of the adhesive should be at most 400° F. as measured by Differential Scanning Calorimetry (DSC). It has also been found that too little ester content may result in insufficient cohesive strength in the adhesive layer, while too much drives the melt onset temperature too low, resulting in an adhesive layer that is sticky and difficult to handle.

Accordingly, carboxylic acid monomer unit(s) and optionally salt(s) thereof typically constitute at least 0.5 wt %, or at least 1 wt %, or at least 2 wt % of the combined one or more polymers. They typically constitute at most 20 wt %, or at most 10 wt %, or at most 7 wt %, or at most 5 wt %. As used herein, weight percentages of carboxylic acid monomer unit(s) and their salt(s) are calculated on the basis of the free, unneutralized acid. Counterions for neutralized carboxylic acid monomer unit(s) (i.e., salts), if present, may be of any type. Typical salts may include metal salts, for example sodium or potassium salts, or ammonium salts, or salts of amines, or combinations of any of these. In some embodiments of the invention, less than 50 mol % of the carboxylic acid groups are in the form of metal salts, or less than 30 mol %, or less than 20 mol %, or less than 10 mol %, or less than 5 mol %. In some embodiments of the invention, less than 50 mol % of the carboxylic acid groups are in the form of salts of any kind, or less than 30 mol %, or less than 20 mol %, or less than 10 mol %, or less than 5 mol %. In some embodiments, none of the carboxylic acid is in the form salt(s). Preferably, no anionic surfactants are included.

In some embodiments of the invention, it may be desirable that the polymer(s) in the adhesive composition contain no monomeric units containing sulfonic acids and/or phosphonic acids, and/or their salts.

Ester-containing monomer unit(s) typically constitute at least 5 wt %, or at least 10 wt %, or at least 15 wt % of the combined one or more polymers. They typically constitute at most 50 wt %, or at most 40 wt %, or at most 30 wt %.

In some embodiments, the ethylene, ester-containing monomer unit(s) and the carboxylic containing monomer unit(s) are all in the same polymer. Alternatively, the adhesive may comprise two (or more) polymers, for example an ethylene vinyl acetate (“EVA”) copolymer and an ethylene (meth)acrylic acid (“E(M)AA”) copolymer. Suitable EVA polymers may contain any relative amount of ethylene and vinyl acetate in polymerized form. Typically, the EVA will have a vinyl acetate content of at least 5 wt %, or at least 15 wt %. Typically, the vinyl acetate content will be at most 35 wt %, or at most 25 wt %.

Suitable E(M)AA copolymers may contain any relative amount of ethylene and (meth)acrylic acid in polymerized form. Typically, they will have a (meth)acrylic acid content of at least 2 wt %, or at least 5 wt %, and at most 20 wt %, or at most 15 wt %, or at most 10 wt %. The (meth)acrylic acid may consist of acrylic acid, or it may consist of methacrylic acid, or any combination of these. In some embodiments where EVA and E(M)AA are used as the adhesive polymers, the weight ratio of EVA to E(M)AA may be at least 20:80, or at least 30:70, or at least 40:60. In those same embodiments, the weight ratio may be at most 80:20, or at most 70:30, or at most 60:40.

In some embodiments of the invention, the adhesive further comprises a tackifier. Typically, the tackifier will be present at a level of at least 1 part, or at least 3 parts, or at least 5 parts per 100 parts of the polymer(s). Typically, the amount will be at most 30 parts, or at most 20 parts, or at most 15 parts per 100 parts of the polymer(s).

Any tackifier known in the art, for example those disclosed in U.S. Pat. No. 3,484,405, can be used. Such tackifiers include a variety of natural and synthetic resins and rosin materials, and can provide substantial and improved tackiness to the composition. Tackifier resins can be liquid, semi-solid to solid, or solid, including complex amorphous materials generally in the form of mixtures of organic compounds having no definite melting point and no tendency to crystallize. Such tackifier resins may be insoluble in water and can be of vegetable or animal origin, or can be synthetic resins. Suitable tackifiers include, but are not limited to, para-coumarone-indene resins, terpene resins, butadiene-styrene resins, polybutadiene resins, hydrocarbon resins, rosins, and combinations of two or more thereof.

Generally the coumarone-indene resins have a molecular weight ranging from about 500 to about 5,000. An exemplary resin of this type is available commercially as PICCO® A100 from Eastman Chemical, Kingsport, Tenn.

The terpene resins include styrenated terpenes and can have a molecular weight ranging from about 600 to 6,000. Examples of commercially available resins are marketed as PICCOLYTE® S-100 (Pinova, Brunswick, Ga.). An exemplary terpene resin-based tackifier is available as PICCOLYTE® C115, and is derived from polylimonene.

Also suitable are low molecular weight (e.g., about 1300) styrene hard resins such as a product marketed as PICCOLASTIC® A75 by Eastman Chemical. Suitable rosin-based tackifiers may be derived from gum, wood or tall oil rosin. The tackifier may be based on a modified rosin such as dimerized rosin, hydrogenated rosin, disproportionated rosin, or esters of rosin, typically prepared by esterifying the rosin with polyhydric alcohols containing from 2 to 6 hydroxyl groups. An exemplary rosin-based tackifier is sold commercially as STAYBELITE ESTER® #10 by Eastman Chemical, and is a glycerol ester of hydrogenated rosin.

Other additives may also be included in the adhesive compositions of the invention, for example antiblock additives such as waxes. One suitable antiblock additive is erucamide.

One suitable adhesive composition includes the following ingredients, reported on a dry solids basis. This composition may be dispersed in water with a small amount of ammonia, at a solids level of about 35 wt %. In this composition, acrylic acid constitutes about 3 wt % of the combined ethylene acrylic acid (EAA) and ethylene vinyl acetate (EVA) copolymers, and vinyl acetate constitutes about 20 wt %.

| | |
|---|---|
| 14% | EAA copolymer, 15-20 wt % AA content |
| 63% | EVA copolymer, 24 wt % VA content |
| 21% | Hydrogenated rosin ester tackifier resin |
| 2% | Dioctyl phthalate plasticizer, stearyl amide slip additive, BHT |
| | antioxidant |

A commercially available adhesive having approximately this composition is available as a 35% solids dispersion from Dow Chemical (Midland Mich.) under the trade name ADCOTE™ 37T77E dispersion.

### Nylon Substrates

Generally speaking, suitable nylon substrates may be any of the nylons or blends of nylons. Minor amounts of polymers and additives compatible with nylon may be included. For those applications where the composite film will be subjected to temperatures only up to about 220° F., any of the nylons have adequate heat stability, and criteria other than heat tolerance may be used to select the most desirable nylon compositions.

For those applications where the composite film will be subjected to retort-type temperatures, such as up to 275° F., the selection of acceptable nylon polymers is somewhat more limited, as not all nylons are capable of withstanding the process conditions. Suitable exemplary nylons for such conditions include nylon 6, nylon 66, nylon 6/66 copolymer, nylon 11, and blends of nylon 6 and nylon 11. In some suitable blends of nylons, for example thermoformable blends, up to 25 wt % of nylon 12 may be included. In some embodiments of the invention, a layer of polyvinylidene chloride may be applied to the nylon layer, for example using solution or extrusion coating methods known in the art. Typically, the layer is coextensive with the nylon layer, i.e., equal in shape and size to an entire surface of the nylon film. Providing such a layer, either between the nylon and the heat seal layer or on the side opposite the heat seal layer, may improve barrier properties with respect to moisture and oxygen.

### Applying the Adhesive Composition

The adhesive compositions are applied as aqueous dispersions, typically using ammonia or a volatile amine to help solubilize and/or disperse the carboxyl-containing adhesive resin(s). Application may be effected by any coating means known in the art, such as by use of a Myer rod, a gravure coater or a doctor blade, followed by drying. In some embodiments the heat seal coating may be coextensive with the nylon film.

### Packages Employing the Composite Film

The invention also provides a package comprising a lid made from the composite film of this invention, heat sealed to a bottom part such as a tray. Exemplary tray materials commonly used in packaging applications include thermoformed polyester, amorphous PET, impact-modified PET, polypropylene, and polystyrene. In other embodiments, the composite film can be formed into a bag, for example for packaging raw or processed meat.

### EXAMPLES

### Adhesive Coatings on Nylon 6,6 Films

Nine adhesive compositions were evaluated, each being coated onto a nylon 6,6 film, dried, and evaluated for heat seal strength. Approximate compositions of the compositions, as determined by a combination of analytical methods and commercial literature, were as follows.

ADCOTE™ 37T77E—a water-based dispersion based on high molecular weight ethylene interpolymers, having a composition approximately as described above.

AQUASEAL® 2009—an EVA copolymer having no carboxylic acid monomer units, available commercially from Paramelt BV, Costerstraat 18, P.O. Box 86, NL-1700 AB Heerhugowaard.

MICHEM® Emulsion D791—an EVA copolymer and EAA copolymer dispersion having an approximately 24 wt % acetate content available commercially from Michelman, Inc. of Cincinnati, Ohio.

MICHEM® Emulsion D796—an anionic dispersion of a copolymer comprising ethylene, a carboxylic acid-containing monomer and methyl acrylate, having an approximately 20 wt % methyl acrylate content.

MICHEM® Emulsion D797—an anionic dispersion of a copolymer comprising ethylene, a carboxylic acid-containing monomer and butyl acrylate, having an approximately 22 wt % butyl acrylate content.

MICHEM® Emulsion D970—an anionic polyolefin dispersion having no ester or carboxylic acid monomer units.

AQUASEAL® 2045—a metal salt of an ethylene/methacrylic acid copolymer having a 20% methacrylic acid content, available from Paramelt BV.

AQUASEAL® 2200—a polyethylene copolymer with high polypropylene content and no ester or carboxylic acid monomer units, available from Paramelt BV.

AQUASEAL® 2105—an EAA copolymer having no ester monomer units, available from Paramelt BV.

The general coating method for ADCOTE™ 37T77E is as described below, and the other coatings were applied analogously.

ADCOTE™ 37T77E dispersion (35% solids, from Dow Chemicals) was diluted to 25% solids by adding deionized water with agitation. This solution was coated on a 1 mil thick nylon 6,6 film (Dartek® N201 from Exopack) by using a #4 Meyer rod. The wet coating was dried in an oven at 180° C. for 30 seconds. The resulting film had a dry coating thickness of 9 microns.

### Heat Seal Strength Measurement

One half of a coated A4 sheet of nylon film was sealed to itself (coated side to coated side) using a Sentinel heat sealer (Model 12 by Packaging Industries Group Inc.). The heat sealer parameters were: 150° C. (top jaw), 40° C. (bottom jaw)/1 second/80 psi. The sealed sample was marked and cut into 25 mm width strips, the folded portion was slit and the heat seal strength was determined by peel strength testing on an INSTRON® model 4464 test machine. The jaws were set 50 mm apart. The upper jaw held one piece of the sealed sample and traveled up at a speed of 250 mm/min, while the lower jaw held the other piece of the sealed sample and was stationary. The maximum force needed to separate the two pieces of film was recorded. Five sealed sample pieces were measured for each of the nine coated samples. The results are shown in Table 1.

TABLE 1

| | Max. | |
|---|---|---|
| | peel | |
| | strength | Standard |
| Adhesive Composition | (g/in) | deviation |
| ADCOTE ™ 37T77E | 1209 | 148 |
| *AQUASEAL ® 2009 | 129 | 34 |
| MICHEM ® Emulsion D791 | 1659 | 164 |
| MICHEM ® Emulsion D796 | 1482 | 63 |
| MICHEM ® Emulsion D797 | 1590 | 41 |
| *MICHEM ® Emulsion D970 | 207 | 49 |
| *AQUASEAL ® 2045 | 280 | 70 |
| *AQUASEAL ® 2200 | 233 | 111 |
| *AQUASEAL ® 2105 | 305 | 50 |

*comparative examples

The compositions listed above as comparative examples were those in which ester monomer units and/or carboxylic acid monomer units were not present, while the examples according to the invention included both of these along with ethylene in the polymer(s) present in the dispersion. As can be seen, the measured peel strengths of films according to the invention were significantly greater than for the comparative examples.

Although the invention is illustrated and described herein with reference to specific embodiments, the invention is not intended to be limited to the details shown. Rather, various modifications may be made in the details within the scope and range of equivalents of the claims without departing from the invention.

1. A composite film comprising a nylon base film and a coextensive layer of adhesive composition comprising one or more polymers, wherein the one or more polymers taken together comprise in polymerized form:
a) ethylene;
b) one or more ester-containing monomers, constituting in a range from 5 to 50 wt % of the one or more polymers; and
c) one or more carboxylic acid-containing monomers and optionally salt(s) thereof, constituting in a range from 0.5 to 20 wt % of the one or more polymers.

2. The composite film of claim 1, wherein the one or more carboxylic acid-containing monomers and optionally salts thereof constitute in a range from 2 to 5 wt % of the one or more polymers.

3. The composite film of claim 1, wherein the one or more ester-containing monomers constitute in a range from 15 to 30 wt % of the one or more polymers.

4. The composite film of claim 1, wherein the one or more polymers comprise
a) an ethylene vinyl acetate copolymer having a vinyl acetate content in a range from 5-35 wt %; and
b) an ethylene (meth)acrylic acid copolymer and optionally salt(s) thereof having a (meth)acrylic acid content in a range from 2-15 wt %.

5. The composite film of claim 4, wherein the vinyl acetate content is in a range from 15-25 wt %.

6. The composite film of claim 4, wherein the content of (meth)acrylic acid and optionally salt(s) thereof is in a range from 5-15 wt %.

7. The composite film of claim 1, wherein less than 50 mol % of carboxylic acid groups are in the form of metal salt(s) thereof.

8. The composite film of claim 1, wherein the adhesive composition further comprises from 1-30 parts of a tackifier per 100 parts of the combined weight of the one or more polymers.

9. The composite film of claim 1, wherein the tackier is a rosin-based tackifier.

10. The composite film of claim 1, wherein the adhesive composition further comprises an antiblock additive.

11. The composite film of claim 1, further comprising a polyvinylidene chloride layer.

12. A package comprising a lid made from the composite film of claim 1, wherein the lid is heat sealed to a tray.

13. The package according to claim 12, wherein the package is capable of self-venting during a cooking cycle.

14. A bag made from the composite film of claim 1, suitable for packaging raw or processed meat.

15. The bag according to claim 14, wherein the bag is capable of self-venting during a cooking cycle.

16. A method of packaging food, comprising heat sealing the composite film according to claim 1 to a tray containing a food item.

17. method of packaging food, comprising closing a bag made from the composite film according to claim 1 by heat sealing, wherein the bag contains a food item.
